(19) United States
(12) Patent Application Publication
(10) Pub. No.: US 2025/0319924 A1
(43) Pub. Date: Oct. 16, 2025

(54) STEERING SYSTEM HAVING A STEERING DEVICE, VEHICLE HAVING A NUMBER OF STEERING AXLES AND METHOD FOR GENERATING A STEERING WHEEL RESISTANCE IN THE VEHICLE

(71) Applicant: ZF CV Systems Global GmbH, Bern (CH)

(72) Inventor: Janik RICKE, Uetze-Eltze (DE)

(21) Appl. No.: 19/177,660

(22) Filed: Apr. 14, 2025

(30) Foreign Application Priority Data
Apr. 15, 2024 (DE) 10 2024 110 470.8

(51) Int. Cl. B62D 5/00

(52) U.S. Cl. CPC B62D 5/006

(57) ABSTRACT

A steering system including a steering device, a steering actuation system for a number of steering axles, a monitoring device, and a steering wheel force actuation system configured to generate a steering wheel resistance. The steering wheel force actuation system includes a reception interface configured to provide a number of steering force resistance values associated with a number of steering axles in a case of a steering angle adjustment of one or more steering axles, a transformer configured to convert steering force resistance values to a steering wheel resistance value, and an output configured to output the steering wheel resistance value. The transformer is configured to combine the steering force resistance values to form an overall steering force. The transformer is also configured to form an overall substitute value from the overall steering force value and to specify the steering wheel resistance value from the overall substitute value.

### CROSS REFERENCE TO RELATED APPLICATIONS

This application claims benefit to German Patent Application No. DE 10 2024 110 470.8, filed on Apr. 15, 2024, which is hereby incorporated by reference herein.

### FIELD

The present invention relates to a steering system, to a vehicle having a number of steering axles and the aforementioned steering system, and to a method for generating steering wheel resistance during operation of a vehicle.

### BACKGROUND

In conventional steering systems, a steering wheel of a steering device is mechanically connected to a wheel steering angle setting means in the form of a steering gear and a steering column.

However, a steering system mentioned at the outset—also known as a so-called steer-by-wire steering system (SbW steering system)—has no direct mechanical connection between a steering handle, such as the steering wheel of the steering device, and the vehicle wheels steered by means of a steering actuation system of steering axles. Such steer-by-wire steering systems may be in the form of electromechanical or also electro or mechanical/hydraulic steering systems. The common feature of such steering systems, that is to say steer-by-wire steering systems, mentioned at the outset is that the steering wheel of the steering device has no mechanical connection to the steering actuation system.

This means that feedback, in particular force feedback, is also no longer provided to the steering wheel due to the lack of a mechanical connection between the steering actuation system and the steering device. Nevertheless, it is—among other things for the driving feel of a human driver operating the steering wheel, but also for sensory feedback to a virtual driver in the event of an autonomous driving process or as a back-up for a driving or steering assistance system—expedient to provide that feedback to the operation system of the steering wheel despite the lack of a mechanical connection by means of a feedback value, in particular for a steering wheel counterforce in the sense of force feedback.

For example, it may be expedient to have a steering resistance of a resistance at the vehicle wheel available as a signal; this can signal an adequate steering force resistance with a corresponding steering wheel resistance value.

In particular, this is essential for vehicle safety if a vehicle wheel of a steering axle, in particular a front axle and/or an auxiliary steering axle is obstructed, for example at a kerb or an obstacle.

A relatively complex system for actuating an electromechanical steering system of a vehicle comprising a driver assistance system is known, for example, from WO 2022/199761 A1.

Lift axles are known in principle from the prior art. There is also a lift axle function that raises the rear axle of the trailer when cornering to reduce the turning circle.

A steering system of the type mentioned at the outset is also known, for example, from DE 10 2022 211 595 A1. In the steer-by-wire steering system described in said document, a motor is operatively connected to the steering wheel and can be controlled in such a way that a force is applied to the steering wheel. The force is adjusted according to the setting of an auxiliary force steering system via a relatively complex transmission mechanism described in said document.

While such a steering system is in principle able to communicate said feedback as a steering wheel resistance to the steering wheel in direct response to the steering wheel adjustment for steering a front axle as the only steering axle, such a steering system is still able to be improved.

DE 10 2020 206 435 B4 describes an alternative steering system that simulates a largely simulated feedback actuator for generating a steering resistance and/or a restoring torque acting on a steering handle according to a simulation function.

However, the adjustment of a feedback actuator by means of a simulation function has limitations when it comes to delivering feedback that is immediate and realistic—albeit virtual, so to speak—that is to say calculated, in particular determined in a measurement-sensor-based and/or model-based manner, by means of a steering wheel resistance to the steering wheel in direct response to the steering wheel adjustment, taking into account a steering axle, in particular a plurality of steering axles.

### SUMMARY

In an embodiment, the present disclosure provides a steering system comprising a steering device having a steering wheel, a steering actuation system for a number of steering axles, a monitoring device of the steering actuation system, and a steering wheel force actuation system configured to generate a steering wheel resistance. The steering wheel force actuation system comprises a reception interface configured to provide a number of steering force resistance values of steering resistances associated with a number of steering axles in a case of a steering angle adjustment of one or more steering axles, a transformer configured to convert steering force resistance values to a steering wheel resistance value, and an output interface configured to output the steering wheel resistance value. The transformer is configured to combine the steering force resistance values to form an overall steering force by generating an overall steering force value from the steering force resistance values, the overall steering force value being representative of a number of steering axles. The transformer is also configured to form an overall substitute value representative of the number of steering axles from the overall steering force value and to specify the steering wheel resistance value representative of the number of steering axles from the overall substitute value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an embodiment of a vehicle having a number of steering axles and a steering system in a schematic form according to the present disclosure;

FIG. 2 illustrates a flow diagram in an embodiment of a method for generating a virtual but realistic steering wheel resistance during operation of the vehicle having a number of steering axles, as shown in FIG. 1, according to the present disclosure; and

FIG. 3 illustrates a detailed flow diagram of the method shown in FIG. 2.

### DETAILED DESCRIPTION

In an embodiment, the present disclosure provides a steering system of the type mentioned at the outset in a manner improved compared to the aforementioned prior art. In particular, the steering system of the present disclosure provides an, in particular calculated, provision of a steering wheel resistance in an improved manner in direct response to a steering wheel adjustment of a steering wheel of a steering device.

Embodiments of the present disclosure improve a steering system with regard to a vehicle having a number of existing steering axles, that is to say not only a steerable front axle, but also a trailing axle as an auxiliary steering axle as well as an optional lift axle as an auxiliary steering axle.

The foregoing improvements are achieved in particular with regard to a number of active steering axles, that is to say embodiments of the present disclosure provide a steering system advantageously within the framework of the aforementioned aspects with regard to the number of active steering axles, especially in the sense of actively steered axles. In particular, this relates to the active steering axles actually in operation. The foregoing improvements are achieved in a much more complex way, if not only the front axle is in operation as an active steering axle in a steering system of a vehicle, but also other steering axles, in particular active steering axles.

In order to illustrate this problem in particular, it should be noted that until now electromechanical or electrohydraulic steering systems without a mechanical connection to the steering wheel that nevertheless actuate multiple steering axles have been implemented in different ways. For example, a front (first) steering axle can be connected to a second steering axle on the vehicle, for example. In this case, feedback can be generated, so to speak, mechanically, for a steering system (relating to the front axle) for a second steering axle.

However, there are also increasingly systems in which the second steering axle—that is to say an auxiliary steering axle such as a trailing axle or a lift axle—is also available without mechanical forced steering and is particularly optionally active.

The problem with a steering system for a number of steering axles, in particular with a steerable front axle and at least one steerable auxiliary steering axle, is that, especially for the auxiliary steering axle designed as a steering axle—for example a steerable trailing axle or, optionally and if active, a steerable lift axle—the steering system is designed without feedback to a steering wheel of the steering device. This may lead to situations in which a steering wheel adjustment is provided and in which feedback, in particular in the above sense as force feedback, is provided regarding the front axle, but not regarding the auxiliary steering axle. The aforementioned problem therefore still exists, especially for the auxiliary steering axle.

Accordingly, the present disclosure relates to a steering system comprising a steering device having a steering wheel, a steering actuation system for a number of steering axles and a monitoring device of the steering actuation system as well as a steering wheel force actuation system for generating an, in particular calculated, steering wheel resistance.

Provision is made for the steering wheel force actuation system to comprise:
a reception interface for providing a number of steering force resistance values of steering resistances associated with a number of steering axles in the case of a steering angle adjustment of one or more steering axles,
a transformer module for converting the steering force resistance values to a steering wheel resistance value,
an output interface for outputting the steering wheel resistance value.

According to the present disclosure, provision is furthermore made for the transformer module to be designed:
to combine the steering force resistance values to form an overall steering force by generating an overall steering force value from the steering force resistance values, said overall steering force value being representative of a number of steering axles,
to form an overall substitute value representative of the number of steering axles from the overall steering force value, and
to specify the steering wheel resistance value representative of the number of steering axles from the overall substitute value.

The present disclosure also relates to a vehicle having a number of steering axles and the steering system according to the present disclosure with regard to the first aspect. In the case of the vehicle, provision is additionally made for
the steering actuation system to comprise a steering angle specification module for adjusting a number of steering angles that can be adjusted by means of control actuators at the number of steering axles, and
the monitoring device of the steering actuation system has a steering actuator sensor system for ascertaining a number of steering forces that can be determined as resistance at the number of steering axles.

The present disclosure is based on the consideration that steering systems of the type mentioned at the outset can be designed in any case with respect to a single steering axle with mechanical support and/or suitable simulation with suitable feedback as a direct response to a steering wheel adjustment by applying a corresponding steering wheel resistance to the steering wheel. Such a purely simulated design, however, reaches its limits when it involves a number of steering axles, in particular comprising a front axle as a steering axle and at least one auxiliary steering axle. This is especially true if the auxiliary steering axle is designed, for example, as a trailing axle and/or—optionally as an active—lift axle.

The present disclosure is based on this basic assumption that steering systems having a generated, in particular calculated, steering wheel resistance can be designed to be able to be improved. The calculated generated steering wheel resistance is thus a steering wheel resistance that is particularly advantageously made available and determined realistically.

The present disclosure has recognized that the steering wheel resistance in a multi-axle steerable vehicle—that is to say having a primary steering axle, in particular a front axle as the primary steering axle, and an auxiliary steering axle—in any case requires an improved design approach in order to determine that steering wheel resistance in an advantageously particularly realistic manner—that is to say to generate it in particular in a suitably calculated manner, in particular in the present case to generate it in a measurement-sensor-based and/or model-based manner, in the case of a multi-axle steerable vehicle.

For this reason, the present disclosure provides the aforementioned transformer module—for converting the steering force resistance values to a steering wheel resistance value—as part of the steering wheel force actuation system.

The transformer module is designed to convert a number of steering force resistance values, which are accordingly associated with the number of steering axles, to a steering wheel resistance value, in particular to convert same into a calculated steering wheel resistance value. In particular, the steering wheel resistance value can be calculated on the basis of a measurement-sensor-based and/or model-based basis.

According to the present disclosure, the transformer module is designed:
to combine the steering force resistance values to form an overall steering force by generating an overall steering force value from the steering force resistance values, said overall steering force value being representative of a number of steering axles,
to form an overall substitute value representative of the number of steering axles from the overall steering force value, and
to specify the steering wheel resistance value representative of the number of steering axles from the overall substitute value.

The present disclosure has recognized that it is advantageous to combine the number of steering force resistance values to form an overall steering force in which an overall steering force value, which is representative of a number of steering axles, is generated from the steering force resistance values. In particular, therefore, the steering system, in particular the transformer module, can take into account the number of steering axles for generating an overall steering force value; preferably for the primary, in particular front, steering axle as well as for an auxiliary steering axle, in particular one or more optional auxiliary steering axles.

In the aforementioned examples, this can optionally be a trailing axle, which can preferably also be continuously active, in the sense of actively steered, as an auxiliary steering axle, and can be in operation. In the aforementioned examples, this can also be optionally an auxiliary steering axle or multiple auxiliary steering axles, which is/are “only” active as required, for example as lift axles, in the sense of actively steered and is/are optionally in operation.

The transformer module can preferably be designed to provide from a number of steering axles, in particular active steering axles, depending on the operating situation, the mentioned steering force resistance values for ascertaining an overall steering force value representative of the number of steering axles, in particular active steering axles.

The transformer module can also preferably be designed to provide from one or more steering axles operating as required according to the operating situation or steering axles not operating as required (for example obstructed steering axles) the mentioned steering force resistance values for ascertaining an overall steering force value representative of the number of steering axles, in particular active steering axles.

In a particularly preferred development listed here in non-restrictive fashion, provision is made in particular for the generated overall steering force value to be representative of a number of active steering axles, specifically actively steered steering axles, in particular active steering axles in operation, wherein an overall substitute value representative of the number of active steering axles can be formed from the overall steering force value, and
the steering wheel resistance value representative of the number of steering axles can be specified from the overall substitute value.

According to the present disclosure, provision is made to form an overall substitute value representative of the number of steering axles from the overall steering force value and to specify the steering wheel resistance value representative of the number of steering axles from the overall substitute value.

With such a steering system, it is provided to generate advantageously, in particular in a calculated manner, depending on the operating situation, a steering wheel resistance that can be applied to the steering wheel in direct response to the steering wheel adjustment.

An embodiment of the present disclosure is thus based on an actual recording of the steering force resistance values associated with the available steering axles, in particular the steering axles active on the vehicle—the concept of the present disclosure thus expressly distances itself from a pure simulation of the steering wheel resistance, but is based on the recognized necessity in any case for a steering axle, to record a steering force resistance value for the number of steering axles, especially for the number of active steering axles.

In other words, a kind of virtual coupling of the axles is specified, in particular for generating a steering wheel resistance in a calculated manner. The virtual coupling of the axles in this respect is specified by—in other words—the steering forces being combined in a calculated manner, that is to say mathematically in the most general sense; the corresponding signal of an overall steering force value or an overall substitute value representative of the number of active steering axles is particularly preferably digital (in this respect actual and not virtual) and then ensures—for example using a torque feedback unit of the steering wheel—the resistance. This means that steering force resistance values are provided to a torque feedback unit or similar transformer module for converting the steering force resistance values to a steering wheel resistance value. An output interface is then used to output the steering wheel resistance value as feedback to a feedback module—the torque feedback unit or similar transformer and/or feedback module is provided, by means of which a steering wheel resistance value can be fed back to the steering wheel as feedback in direct response to a steering wheel adjustment.

In addition, the transformer module according to an embodiment of the present disclosure makes provision for the steering force resistance values to be converted to a steering wheel resistance value according to a preferred procedure, which satisfies the weighting known in the sense of force feedback or in itself realistic weighting of one steering axle relative to the other, that is to say for example the primary steering axle to the auxiliary steering axle.

Embodiments of the present disclosure and the associated advantages apply equally to the steering system as to the vehicle and a method for generating a virtual, but realistic, that is to say calculated, steering wheel resistance during operation of the vehicle having the number of steering axles. The calculated steering wheel resistance proves to be particularly realistic if it has a measurement-sensor-based and/or model-based basis for the calculation.

In a second aspect, the present disclosure relates accordingly to a method for generating a steering wheel resistance during operation of a vehicle having a number of steering axles, in particular by means of a steering system of the present disclosure, in particular in a vehicle of the present disclosure. The steering wheel resistance is particularly advantageously determined in a virtual but realistic way, that is to say calculated and determined in a measurement-sensor-based manner and/or model-based manner.

The method comprises the following steps:
adjusting a number of steering angles by means of control actuators at the number of steering axles according to a steering wheel adjustment,
monitoring a steering actuation system for a number of steering axles,
generating an, in particular calculated, steering wheel resistance by means of a steering wheel force actuation system, wherein, for the steering wheel force actuation system:
   a number of steering force resistance values of steering resistances that are associated with one or more steering axles of a number of steering axles in the case of a steering angle adjustment are provided,
   the steering force resistance values are converted to a steering wheel resistance value,
   the steering wheel resistance value is output.

According to the present disclosure, provision is furthermore made in the method for
the steering force resistance values to be combined to form an overall steering force by generating an overall steering force value from the steering force resistance values, said overall steering force value being representative of a number of steering axles,
an overall substitute value representative of the number of steering axles to be formed from the overall steering force value, and
the steering wheel resistance value representative of the number of steering axles to be specified from the overall substitute value,
the steering wheel resistance to be applied to the steering wheel in direct response to the steering wheel adjustment.

In an embodiment, provision is made for the overall substitute value to be a standard value, wherein the standard value is a value selected from the group of values consisting of: average value, weighted average value, expected value, estimated value; or a value designed to directly indicate an obstruction.

In an embodiment, provision is made for the overall steering force value to be ascertained by adding the steering force resistance values, in particular with relative weighting of the steering force resistance values associated with a number of steering axles.

In an embodiment, provision is made for the overall steering force value to be ascertained by calibrating the steering force resistance values associated with a number of steering axles to a reference axle from the number of steering axles.

In an embodiment, provision is made for the overall steering force value to be ascertained by calibrating the steering force resistance values associated with a number of steering axles to a reference axle from the number of steering axles in such a way that the relative weighting of the steering force resistance values associated with a number of steering axles is specified for the addition of the steering force resistance values with the relative weighting thereof.

In an embodiment, provision is made for the monitoring device of the steering actuation system having a steering actuator sensor system to be designed to ascertain a number of steering forces that can be determined as steering force resistance values at the number of steering axles.

In an embodiment, provision is made for the monitoring device of the steering actuation system having a steering actuator controller to be designed to ascertain a number of steering angles that are added over time and can be used as a substitute for steering force resistance values at the number of steering axles.

In an embodiment, it must also be understood that a change in steering angle can be evaluated in a particularly preferred manner together with a controlled steering force. The evaluation of a change in steering angle together with a controlled steering force can be used in a particularly preferred manner to measure a speed over time or similar measure of time. The basic assumption for this is that, if a steering axle moves more slowly, a steering resistance is greater with the same steering force than if the steering axle moves more quickly.

In an embodiment, each steering actuator sensor or all steering actuator sensors is or are designed in particular to ascertain a number of steering forces or obstructions that can be determined as a resistance at the number of steering axles or can be determined as force expenditure in the steering actuation system. These resistances of, amongst other things, steering forces or obstructions or other resistances not mentioned here can be sensed as a force signal or as an obstruction signal by means of the steering actuator sensor system. The steering forces absorbed and, if applicable, obstruction values are then advantageously combined to form an overall steering force by specifying an overall steering force value for the vehicle in order to be able to output the feedback for all or selected steering axles.

For example, in the event of an obstruction, instead of a mean value, one could use a maximum value as the overall substitute value to output a corresponding value, or send it “to the steering wheel”. If, for example, a rear axle were obstructed, but the front steering axles are freely steerable, the average would be formed.

A deviation from a normal value “per steering axle” can also advantageously be sensed. The maximum value thereof could then be used as an overall substitute value to output a corresponding value or to pass it “to the steering wheel”—an arrangement on a receiver side could be carried out as required in such a way that this can be interpreted as an obstruction.

On the other hand, a standard value, in particular an average as a standard value or overall substitute value, could in certain cases, especially in the case of an obstruction, lead to the driver possibly continuing to unknowingly steer against a kerb.

It is therefore preferable in such or similar cases, in particular in an alternative development, that an obstruction value for at least one axle is used such that the obstruction value is used to generate “feedback” at the steering wheel; this means specifically that it has proven to be advantageous in this case that an average is no longer formed or instead this aforementioned “feedback” generation—in this sense as in the most general way as an alternative form of an overall substitute value—is used at the steering wheel to indicate an obstruction.

In an embodiment, provision is made for at least one steering force resistance value and the overall steering force value to be representative at least of the front axle, taking into account at least one further steering axle of the number of steering axles.

In an embodiment, provision is made for the overall substitute value to be able to be ascertained from the overall steering force value, taking into account a trailing axle, in the event that the trailing axle is a steering axle.

In an embodiment, provision is made for the overall substitute value to be able to be ascertained from the overall steering force value, taking into account a lift axle, in the event that the lift axle is one of the number of active steering axles.

In an embodiment, provision is made for the steering wheel resistance value to be proportional to the overall substitute value.

Embodiments of the present disclosure will now be described below with reference to the drawing in comparison with the prior art. The drawing is not necessarily intended to illustrate the embodiments to scale; rather, the drawing takes a schematic and/or slightly distorted form where useful for explanatory purposes. With regard to additions to the teachings which are directly evident from the drawing, reference is made to the relevant prior art. Here, it should be taken into consideration that a wide variety of modifications and changes concerning the form and the detail of an embodiment can be made without departing from the general concept of the present disclosure. The features of the present disclosure disclosed in the description and in the drawing can be essential to the development of the present disclosure both individually and in any desired combination. In addition, the scope of the present disclosure covers all combinations of at least two of the features disclosed in the description and/or the drawing. The general idea of the present disclosure is not restricted to the exact form or the detail of the preferred embodiment shown and described below. Where dimensional ranges are specified, values lying within the stated limits are also intended to be disclosed as limit values and able to be used as desired.

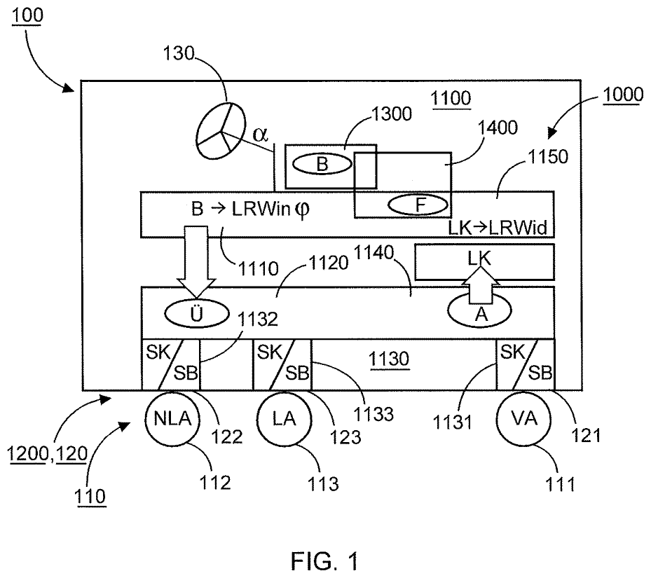

FIG. 1 first schematically shows a vehicle 100, having a number of steering axles 110, specifically in the present case a primary steering axle or reference axle 111 as the front axle VA and a number of auxiliary steering axles, specifically in this exemplary embodiment a first auxiliary steering axle 112 as the trailing axle NLA, which is permanently active in addition to the front axle VA (that is to say actively steered and preferably in operation) and an optionally active additional auxiliary steering axle 113 as the lift axle LA.

In each of these steering axles 110, a control actuator 120 is provided as part of a steering actuation system 1200, by means of which a steering angle φ is adjustable, specifically according to the specification of a steering angle specification module 1300. Here, the control actuators 120 are thus designated symbolically as 121, 122 and 123 for the front axle VA, trailing axle NLA and lift axle LA. The steering angle specification module 1300 is designed to adjust the steering angle φ at a steering axle with the corresponding control actuator 120 according to a steering wheel angle α following the turning of the steering wheel 130. The steering wheel 130 having the steering angle specification module 1300 is illustrated in the present case as part of a steering system 1000, which is explained below in a non-limiting manner and only by way of example with reference to a steer-by-wire steering system (SbW steering system) as a particularly preferred embodiment and to which reference is made in the following as SbW steering system—steering system 1000 for short.

The SbW steering system, that is to say the steering system 1000, as shown in FIG. 1, comprises a steering device 1100 having the steering wheel 130, the steering actuation system having said control actuators and a steering wheel force actuation system 1110, which is essential with regard to an embodiment of the present disclosure.

The steering wheel force actuation system 1100 comprises not only the aforementioned steering angle specification module 1300 for adjusting a number of steering angles, which are then adjustable by means of control actuators 1200 at the number of steering axles 110, but also a feedback module 1400, by means of which a steering wheel resistance value can be fed back to the steering wheel 130 in direct response to a steering wheel adjustment.

According to a steering wheel adjustment of the steering wheel 120, a number of steering angles φ can be adjusted by means of the control actuators 120 at the number of steering axles 110. This means that the steering wheel 130 is subject to external activation B and feedback from the feedback system 1400.

The steering wheel 130 is electromechanically or electrohydraulically coupled to the steering angle specification module 1200, at least without a mechanical connection and is thus characteristic of the steering system 1000 due to this lack of mechanical connection—the steering wheel 130 thus has no mechanical connection to either the front axle VA or to the auxiliary steering axle of the steering axles 110.

Furthermore, the steering wheel force actuation system 1110 has a unit for converting the steering wheel angle α of the steering wheel 130 set in accordance with the activation B to a steering angle φ, a monitoring device 1120, for monitoring Ü the steering actuator 1200, having a number of sensors, associated with the steering axles 110, of a steering actuator sensor system 1130, which are denoted here by 1131, 1132, 1133. Each steering actuator sensor is designed to ascertain a number of steering forces SK or obstructions SB that can be determined as a resistance at the number of steering axles 110 or can be determined as force expenditure in the steering actuation system 120, 1200. These resistances of, amongst other things, steering forces SK or obstructions SB or other resistances not mentioned here can be sensed as a force signal or as an obstruction signal by means of the steering actuator sensor system 1130.

It is also possible that no force is detected for this purpose, but in this respect a steering actuator sensor system 1130 is implemented as a virtual sensor system. For example, detection of a steering angle φ over time can be provided, which is intended as a substitute for force sensing; for example, a steering angle φ could be integrated over time, so that then an equivalent or a substitute for a steering force SK or obstruction SB is determined via this measure as the relevant value of steering forces, which can be determined as a resistance at the number of steering axles.

The steering actuator sensor system 1130 is designed to provide steering force resistance values of steering resistors to a reception interface A, which values are associated with the same number of steering axles 110 when the steering angle φ of one or more steering axles 110 is adjusted.

The reception interface 1140 is used to receive A the ascertained signals for the number of steering forces SK or obstructions SB-insofar as they are part of the monitoring process U. The number of steering force resistance values LK associated with the number of steering forces SK or obstructions SB for the number of steering axles is stored in a corresponding steering resistance register. The steering force resistance values LK are then made available to a transformer module 1150 for converting the steering force resistance values LK to a steering wheel resistance value LRWid.

An output interface F is then used to output the steering wheel resistance value LRWid as feedback to the feedback module 1400.

In other words, a kind of virtual coupling of the axles 110 is specified, in particular for generating a steering wheel resistance LRWid in a calculated manner, in particular in a measurement-sensor-based manner and/or model-based manner. The virtual coupling of the axles 110 in this respect is specified by—in other words—the steering forces SK, SB being combined in a calculated manner, that is to say mathematically in the most general sense; the corresponding signal of an overall steering force value G-LK or an overall substitute value M-LK representative of the number of active steering axles 110 is particularly preferably digital (in this respect actual and not virtual) and then ensures—for example using a torque feedback unit of the steering wheel—the resistance. This means that steering force resistance values LK are provided by way of a transformer module 1150, which is developed by means of a torque feedback unit or similar unit, for converting the steering force resistance values LK to a steering wheel resistance value LRWid. An output interface F is then used to output the steering wheel resistance value LRWid as feedback to a feedback module 1400—the torque feedback unit or similar transformer and/or feedback module 1150, 1400 is provided, by means of which a steering wheel resistance value LK can be fed back to the steering wheel 130 as feedback in direct response to a steering wheel adjustment.

According to the an embodiment of the present disclosure, provision is now made for the steering force resistance values LK to be combined to form an overall steering force in which an overall steering force value, which is referred to as G-LK in the present case, is generated from the steering force resistance values LK. The overall steering force value G-LK is therefore representative of the number of steering axles 110 in this respect. In other words, the overall steering force comprises—and accordingly the overall steering force value G-LK takes into account—in an example here, for example, the steering force resistance values LK for the front axle VA, 111 and the trailing axle NLA, 112; in the event that the lift axle LA, 113 is raised. In the event that the lift axle LA, 113 contributes to traction, that is to say is lowered and steerable, the overall steering force G-LK can also combine the steering force resistance values LK for all steering axles 110 shown in FIG. 1.

From the overall steering force value G-LK, an overall substitute value M-LK representative of the number of steering axles 110, in particular active and/or operating steering axles 110, is then formed and, from the overall substitute value M-LK, the steering wheel resistance value LRWid representative of the number of steering axles is accordingly specified to the transformer module 1150.

The overall substitute value M-LK is particularly preferably a suitable standard value. The standard value is particularly advantageously a value selected from the group of values consisting of: average value, weighted average value, expected value, estimated value; or a value designed to directly indicate an obstruction.

An average value or a suitably weighted average value has proven to be particularly advantageous for a standard value; this type of selection of an overall substitute value particularly advantageously supports the need for a calculated steering wheel resistance.

Specifically, an overall steering force value as explained can be ascertained by adding the steering force resistance values, in particular with relative weighting of the steering force resistance values associated with a number of steering axles. The overall steering force value can then be ascertained by calibrating the steering force resistance values associated with a number of steering axles to a reference axle from the number of steering axles.

Specifically, it has proven particularly successful that the overall steering force value is ascertained from the number of steering axles in this way by calibrating the steering force resistance values associated with a number of steering axles on a reference axle. This can be done in such a way that the relative weight of the steering force resistance values associated with a number of steering axles is specified for the addition of the steering force resistance values with their relative weighting.

In the example presented here, the overall steering force value G-LK of the steering force resistance values LK associated with a number of steering axles 110 is referred to a reference axle with calibration thereof—in this case, the front axle VA, 111; this means that it is ascertained in such a way that the relative weighting of the steering force resistance values LK associated with the steering axles 110 is specified for the addition of the steering force resistance values with their relative weighting. In the present case, the overall steering force is, so to speak, formed as the mean value of a weighted sum of all steering force resistance values LK.

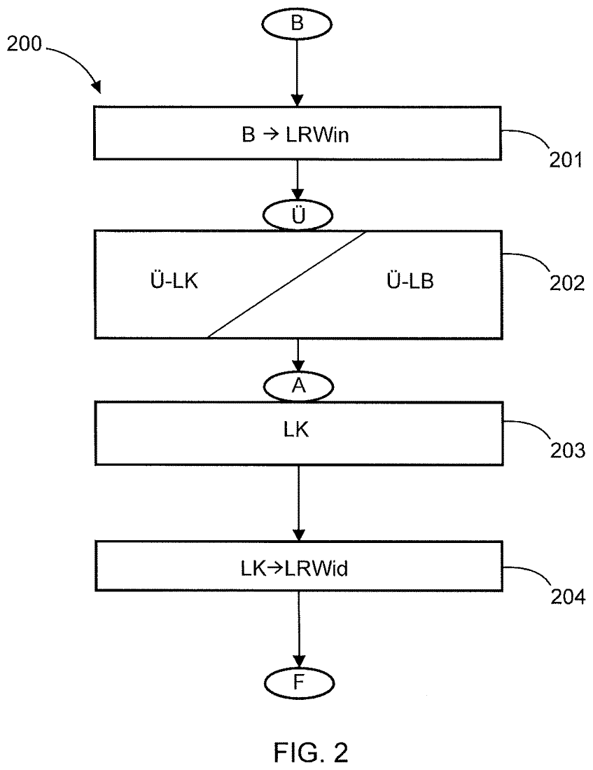

FIG. 2 shows the basic sequence of the method already described schematically here for the steering system 1000.

In the method, the steering wheel 130 is first activated B via an external location; this can be implemented by a personal driver of the vehicle 1000. However, this can also be implemented by a remote control system or via a virtual driver function in the vehicle with planned actuation of a control device; so to speak as a substitute for the steering wheel 130. This means that a steering wheel angle α is adjusted via the activation process B by means of the control means generally understood in the following text as the steering wheel 130.

In step 201, the steering wheel angle α is then converted to a steering angle q (B>LRWin), in the previously explained unit of the steering wheel force actuation system 1110 and provided to the steering actuation system 1200 of the steering axles 110.

Monitoring Ü of the steering actuation system 1120 is followed in step 202 by direct ascertainment of the steering force resistance values either as force value or obstruction value Ü-SK; Ü-SB. The monitoring Ü can be carried out by any suitable means; this can be a previously explained steering actuator sensor system 1130 actually with sensor detection of the steering resistances or can be a calculated substitute therefor; for instance by integration of the steering angle q.

In step 203, the steering force resistance values LK are received A, and then converted to a steering wheel resistance value LRWid in step 204 and provided as feedback to the feedback unit 1400.

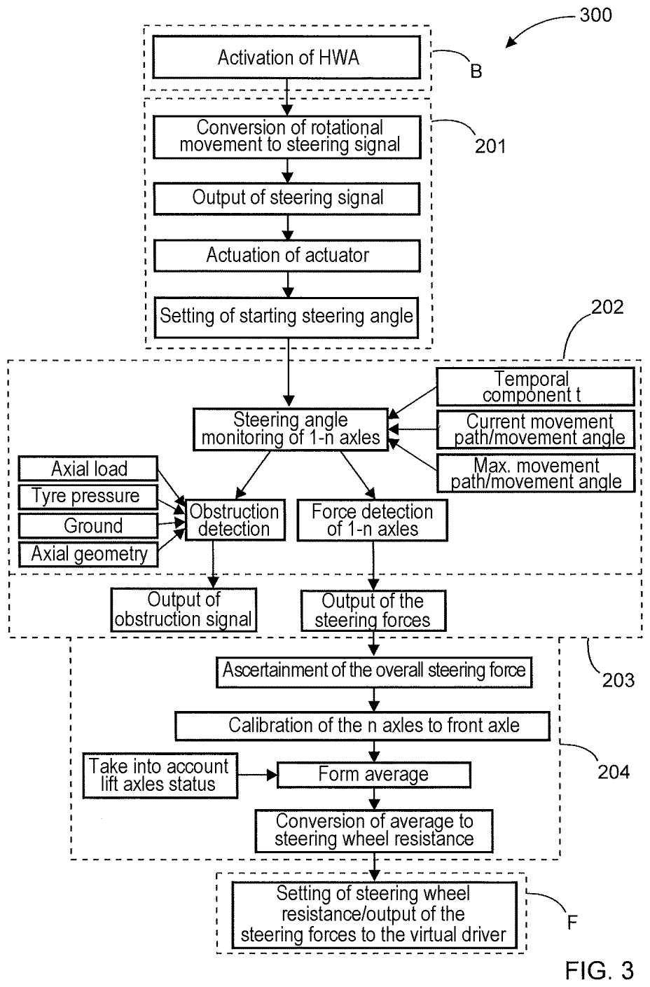

FIG. 3 shows in detail a configuration of the method of FIG. 2. Initially, the so-called HWA (“hand wheel actuator”—steering wheel with sensor to receive the angle of rotation as the steering wheel angle α) is activated B or there is a steering angle specification by the virtual driver or a remote system with a conversion of the rotational movement to a desired steering angle q if necessary.

The activation B can thus be performed manually or the input is performed by a virtual driver or by a remote control-then in particular the steering angle φ can also be directly specified at the wheel by outputting the steering signal and thus a respective steering angle φ to the 1-n steering axles in step 201.

The steering angle φ is used to control and monitor Ü the control actuators 120 in step 202. The steering angles φ are adjusted electrohydraulically or electromechanically. Pneumatic operation is can also be provided. Oil or air is pumped into a cylinder in order to change the steering angle q via a linkage assembly. Or an electric motor, which actuates a linear or rotary actuator via a gear, is actuated.

For step 202, it must be explained in the present case that, during the adjustment of the steering angle q, steering angle monitoring Ü thus takes place. This means that, in the present case of a particular embodiment, the time is recorded by the wheel/wheels swivelling for each steering axle 110. In addition, the current position and the current adjustment angle are recorded and compared with the maximum angle/position. This data is incorporated into obstruction detection. This is performed together with the recording of for example the axle loads, tyre pressure, ground condition, and axle geometry as specifically illustrated in step 202 of FIG. 3. For example, if the adjustment distance over time at one axle deviates from the other axles, an obstruction can thus be detected—in this case a previously explained obstruction value SB can be generated. Another way to detect the obstruction is to measure the pressure in the actuating cylinder or the current consumption of the actuator. Compared to the values of the other axles, an obstruction can be detected therefrom by specifying an obstruction value SB. For example, if the values are 15% above the values of the other axles, a signal Ü-SB indicating the obstruction of a wheel/a steering axle is output.

The steering forces SK absorbed and, if applicable, obstruction values SB are combined in step 203 to form an overall steering force by specifying an overall steering force value G-LK for the vehicle in order to be able to output the feedback for all or selected steering axles. However, in that regard it is preferable in particular that an obstruction value for at least one axle results in the obstruction value being used to generate “feedback” at the steering wheel; this means specifically that it has proven to be advantageous in this case that an average is no longer formed or instead the “feedback” generation is used at the steering wheel to indicate an obstruction.

In order to generate feedback therefrom for the driver in step 204, the steering forces SK, SB or, in general, the steering force resistance values LK associated therewith are calibrated. Calibration can be understood as a virtual coupling. This means that a reference axle 111 is selected, preferably the front axle VA. The values of the 1-n steering axles are calibrated to the reference axle 111. For this purpose, the necessary forces, time periods and adjustment angles are made without units.

In an exemplary illustrative representative case, the reference axle 111 can require, for example, a steering force SK of 10 kN at a standstill. The first auxiliary steering axle 112, NLA requires 12 kN under the same ambient conditions.->SteeringRef 10 kn=100% & Steering2 12 kn=100%.

The conversion factor is 1.2.

This is taken into account in the calculation of the overall steering force by specifying an overall steering force value G-LK. This ensures that there is no distortion in the feedback in step 204 because the geometry of the activation of a steering axle is different.

If the steering forces SK, SB are not measured, it is also provided—as described above—to measure the change in steering angle over time and to calibrate this.

An average is then calculated from the overall steering force value G-LK.

After the calibration of all steering axles 110, an overall steering force is thus ascertained by specifying an overall steering force value G-LK and the average M-LK of all steering axles 110 is formed from this. The calculation of the average M-LK preferably does not take into account raised lift axles, that is to say if these are not in operation.

This average will then be reflected as feedback in the so-called HWA by means of the output interface F. The average does not have to be formed with all axles. For example, only the front axle VA can be set as the steering axle 111 for feedback by means of the output interface F.

However, this method provides the driver with realistic and nevertheless virtual feedback for all steering axles 110, regardless of where they are installed in the vehicle 100.

With this method, the feedback can also be carried out exclusively for the front steering axle VA and the other auxiliary steering axles 112, 113 are only monitored for deviations, such as an obstruction SB. This is particularly important for remote control/virtual driving, where a driver does not notice that the trailing axle is scraping the kerb; an obstruction value Ü-SB is thus equally advantageous in such a case.

In summary, described here is a steering system 1000 comprising a steering device having a steering wheel 130, a steering actuation system 1200 for a number of steering axles 110 and a monitoring device 1120 of the steering actuation system and a steering wheel force actuation system 1100 for generating an, in particular virtual but realistic, steering wheel resistance by means of a steering wheel resistance value LRWid. The steering wheel force actuation system 1100 comprises:
a reception interface 1140 for providing or receiving A a number of steering force resistance values of steering resistances associated with a number of steering axles in the case of a steering angle adjustment of one or more steering axles,
a transformer module 1150 for converting the steering force resistance values to a steering wheel resistance value,
an output interface 1140 for outputting the steering wheel resistance value, according to an embodiment of the present disclosure, provision is made for the transformer module to be designed
to combine the steering force resistance values LK to form an overall steering force by generating an overall steering force value G-LK from the steering force resistance values LK, said overall steering force value being representative of a number of steering axles 110,
to form an overall substitute value M-LK representative of the number of steering axles from the overall steering force value G-LK, and
to specify the steering wheel resistance value LRWid representative of the number of steering axles 110 from the overall substitute value M-LK.

Other variations of the disclosed embodiments can be understood and executed by a person skilled in the art when executing the embodiments of the present disclosure on the basis of the drawings and the disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

100 Vehicle
110 Steering axles
111 Primary steering axle or reference axle
112 Auxiliary steering axle
113 Additional auxiliary steering axle
120 Control actuator
130 Steering wheel
121 VA Front axle
122 NLA Trailing axle
123 LA Lift axle
1000 Steering system, in particular SbW steering system
1100 Steering device
1110 Steering wheel force actuation system
1120 Monitoring device
1130, 1131, 1132, 1133 Steering actuator sensor system
1140, A Reception interface, reception
1150 Transformer module
1200 Steering actuation system
1300 Steering angle specification module
1400 Feedback module
201, 202, 203, 204 Method step
φ Steering angle
B External activation
F Output interface
α, LR Win Steering wheel angle
SK, SB Steering forces
LK Steering force resistance value
LR Wid Steering wheel resistance value
F Output interface, feedback
G-LK Overall steering force value
M-LK Overall substitute value of steering force
Ü Monitoring
Ü-SK Force value
Ü-SB Obstruction value
A Reception interface

What is claimed is:

1. A steering system comprising:
a steering device having a steering wheel;
a steering actuation system for a number of steering axles;
a monitoring device of the steering actuation system; and
a steering wheel force actuation system configured to generate a steering wheel resistance, wherein:
the steering wheel force actuation system comprises:
a reception interface configured to provide a number of steering force resistance values of steering resistances associated with a number of steering axles in a case of a steering angle adjustment of one or more steering axles,
a transformer configured to convert steering force resistance values to a steering wheel resistance value, and
an output interface configured to output the steering wheel resistance value, the transformer is configured to:
combine the steering force resistance values to form an overall steering force by generating an overall steering force value from the steering force resistance values, the overall steering force value being representative of a number of steering axles,
form an overall substitute value representative of the number of steering axles from the overall steering force value, and
specify the steering wheel resistance value representative of the number of steering axles from the overall substitute value.

2. The steering system according to claim 1, wherein the generated overall steering force value is representative of a number of actively steered steering axles in operation,
wherein the overall substitute value is formed from the overall steering force value, and
wherein the steering wheel resistance value is specified from the overall substitute value.

3. The steering system according to claim 1, wherein the overall substitute value is a standard value, wherein the standard value is a value selected from a group of values consisting of: an average value, a weighted average value, an expected value, an estimated value, and a value configured to directly indicate an obstruction.

4. The steering system according to claim 1, wherein:
the overall steering force value is ascertained by adding the steering force resistance values with relative weighting of the steering force resistance values associated with a number of steering axles, and/or
the overall steering force value is ascertained by calibrating the steering force resistance values associated with a number of steering axles to a reference axle from the number of steering axles.

5. The steering system according to claim 4, wherein the overall steering force value is ascertained by calibrating the steering force resistance values associated with a number of steering axles to a reference axle from the number of steering axles such that the relative weighting of the steering force resistance values associated with the number of steering axles is specified for the addition of the steering force resistance values with the relative weighting thereof.

6. The steering system according to claim 1 wherein the monitoring device of the steering actuation system has a steering actuator sensor system, and wherein the monitoring device is configured to ascertain a number of steering forces that can be determined as steering force resistance values at the number of steering axles.

7. The steering system according to claim 1 wherein the monitoring device of the steering actuation system has a steering actuator controller, and wherein the monitoring device is configured to ascertain a number of steering angles that are added over time and can be used as a substitute for steering force resistance values at the number of steering axles.

8. The steering system according to claim 1, wherein at least one steering force resistance value and the overall steering force value is representative at least of the front axle taking into account at least one additional steering axle of the number of steering axles.

9. The steering system according to claim 1, wherein the overall substitute value is ascertained from the overall steering force value taking into account a trailing axle in the event that the trailing axle is a steering axle.

10. The steering system according to claim 1, wherein the overall substitute value is ascertained from the overall steering force value taking into account a lift axle in the event that the lift axle is one of the number of the teering axles.

11. The steering system according to claim 1, wherein the steering wheel resistance value is proportional to the overall substitute value.

12. A vehicle comprising:
a number of steering axles; and
the steering system according to claim 1, wherein:
the steering actuation system comprises a steering angle specification module for adjusting a number of steering angles that can be adjusted by control actuators at the number of steering axles, and
the monitoring device of the steering actuation system has a steering actuator sensor system configured to ascertain a number of steering forces that determined as a resistance at the number of steering axles.

13. A method for generating a calculated steering wheel resistance during operation of a vehicle having a number of steering axles by the steering system according to claim 1, the method comprising:
adjusting the number of steering angles by control actuators at the number of steering axles according to a steering wheel adjustment;
monitoring the steering actuation system for the number of steering axles;
generating a calculated steering wheel resistance by a steering wheel force actuation system, wherein, for the steering wheel force actuation system:
a number of steering force resistance values of steering resistances associated with the number of steering axles in a case of a steering angle adjustment of one or more steering axles are provided,
the steering force resistance values are converted to a steering wheel resistance value, and
the steering wheel resistance value is output, and
wherein:
the steering force resistance values are combined to form an overall steering force by generating an overall steering force value from the steering force resistance values, the overall steering force value being representative of a number of steering axles,
an overall substitute value representative of the number of steering axles is formed from the overall steering force value, and
the steering wheel resistance value representative of the number of steering axles is specified from the overall substitute value; and
applying the steering wheel resistance to the steering wheel in direct response to the steering wheel adjustment.
